(19) United States
(12) Patent Application Publication
(10) Pub. No.: US 2016/0247112 A1
(43) Pub. Date: Aug. 25, 2016

(54) PERSONAL SERVICES PROVIDER GEOGRAPHIC AUTO-SELECTION SYSTEM

(71) Applicant: Warren Smoot CARTER, III, Dallas, TX (US)

(72) Inventor: Warren Smoot CARTER, III, Dallas, TX (US)

(73) Assignee: GoodLook Holdings, Inc., Dallas, TX (US)

(21) Appl. No.: 15/041,259

(22) Filed: Feb. 11, 2016

Related U.S. Application Data
(60) Provisional application No. 62/119,485, filed on Feb. 23, 2015.

(51) Int. Cl. G06Q 10/06; G06Q 10/10

(52) U.S. Cl. CPC G06Q 10/063112; G06Q 10/1095

(57) ABSTRACT

Techniques of selecting a personal service provider. The techniques include using one or more input/output mechanism(s) in computing device(s) to enable interaction with at least a customer through at least a first other computing device and one or more personal service providers through one or more second other computing devices. The techniques also include using tangible computing element(s) in the computing device(s) to perform steps of the techniques. The steps include receiving an order from the customer; selecting the personal service provider(s) based on at least one criteria including skillsets of the personal service providers; transmitting the order to the personal service provider(s); receiving a claim for the order from at least one of the personal service provider(s); and transmitting information to the customer about the personal service provider(s) associated with the claim. Also, systems configured to perform such techniques.

### CROSS-REFERENCE TO RELATED APPLICATION

This application claims the benefit of U.S. Provisional Application No. 62/119,485 titled “PERSONAL SERVICES PROVIDER GEOGRAPHIC AUTO-SELECTION SYSTEM” and filed Feb. 23, 2015 in the name of the same inventor as this non-provisional application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

The present disclosure generally relates to a personal services provider selection system.

### SUMMARY

Aspects of the subject technology include techniques of selecting a personal service provider. The techniques include using one or more input/output mechanism(s) in computing device(s) to enable interaction with at least a customer through at least a first other computing device and one or more personal service providers through one or more second other computing devices. The techniques also include using tangible computing element(s) in the computing device(s) to perform steps of the techniques. The steps include receiving an order from the customer; selecting the personal service provider(s) based on at least one criteria including skillsets of the personal service providers; transmitting the order to the personal service provider(s); receiving a claim for the order from at least one of the personal service provider(s); and transmitting information to the customer about the personal service provider(s) associated with the claim.

In some aspects, the order comprises an order for a combination of service. The steps may also include transmitting a reminder about the order to the customer, transmitting a reminder about the order to the personal service provider(s) associated with the claim, receiving a confirmation or cancellation of the order from the customer, and/or transmitting the confirmation or cancellation to the personal service provider(s) associated with the claim.

In other aspects, the steps may include receiving that service of the order has started. In those aspects, further steps may include notifying an administrator that the at least one of the one or more personal service providers associated with the claim started the service of the order late, receiving that the service of the order has been completed, and/or receiving a rating of the service of the order from the customer.

The one or more computing devices may include a web server. In addition, the first other computing device, the second other computing devices, or both may include mobile computing devices. The subject technology also includes systems configured to perform the above techniques, for example systems including a web server and mobile computing devices.

This brief summary has been provided so that the nature of the invention may be understood quickly. Additional steps and/or different steps than those set forth in this summary may be used. A more complete understanding of the invention may be obtained by reference to the following description in connection with the attached drawings.

### BRIEF DESCRIPTION OF THE DRAWINGS

FIG. 1 illustrates process flow steps related to aspects of the subject technology.

FIG. 2 also illustrates process flow steps related to aspects of the subject technology.

FIG. 3 illustrates hardware that may be used to implement aspects of the subject technology.

### DETAILED DESCRIPTION

U.S. Provisional Application No. 62/119,485 (including its appendices) titled “PERSONAL SERVICES PROVIDER GEOGRAPHIC AUTO-SELECTION SYSTEM” and filed Feb. 23, 2015 in the name of the same inventor as this non-provisional application is hereby incorporated by reference as if fully set forth herein.

Aspects of the subject technology use automated texts, emails, and/or notifications through a program running on a preferably mobile computing device, for example an app running on a mobile phone utilized by a carrier, that may be triggered by various events to auto-select and/or arrange one or more appointments with a personal service provider. The subject technology is described and depicted with respect to a “stylist,” as in a hair stylist, makeup artist, or nail technician. The technology may also be applied to selecting and/or arranging one or more appointments with another type of personal service provider. Examples include but are not limited to a lawn services professional, house cleaning contractor, health care professional, building contractor, roofer, plumber, repairman, and the like.

In this document, <Provider> may represent a person, business, or other entity who employs and/or contracts a personal service provider and provides them with program such as an app for a mobile computing device that delivers service orders based on geography and booking type (i.e. hairstyling booking, makeup booking etc). Alternative, <Provider> may refer to the personal service provider him/herself. <Provider> may also be a third party who uses the subject technology to assist a customer with selecting and/or arranging one or more appointments with a personal service provider and/or his/her employer/contractor.

In general, an example process flow according to the subject technology includes but is not limited to the following:

1. Customer places an order.

2. The order appears on the Stylist App of the stylists that are nearby, for example within a defined distance, geography, and skillset that may vary based on a density of stylists in the area or to a defined number of the closest stylists.
Push notification, for example “New appointment available.”
InApp (i.e., on an app running on a mobile computing device) notification:
   Number of new appointments appear in a bubble next to “Find New” tab.
   When user opens “Find New” tab, the bubble goes away.

3. A stylist claims the job.

4. If no stylists claims the job in 30 minutes (or any other defined time), send a text to an administrator to assign the next available stylist to the appointment via an Administrative System. Preferably allow the administrator to change text notification settings to receive texts on all orders, or just the unclaimed orders.

5a. Send a confirmation text to the customer with information such as but not limited to the following:
“<Provider> stylist, <Stylist's first name>, confirmed for <Appointment date> @<Appointment time> at <Appointment Street Address>. <Stylist's first name> will call 5 min prior to arrival. Thanks for choosing <Provider>!”
Example: <Provider> stylist, <stylist name>, confirmed for 8/25 @5 pm at 123 Street Name Rd. <stylist name> will call 5 min prior to arrival Thanks for choosing <Provider>!

5b. Send push & in-app notification with the following info:
“See your stylist's profile.”
Tap notification to see the stylist's profile info in the app.

6a. Send a reminder text to the customer 12 hours (or any other defined time) before the appointment.
“This is a reminder for your upcoming <Provider> appointment on 8/25 @5 pm at 123 Street Name Rd. with <stylist name>. See prep instructions: <url>”
Tap the url to see prep instructions in the app.

6b. Send reminder text to the stylist 12 hours (or any other defined time) before the appointment, for example but not limited to the following: “Appointment Reminder: 8/25 @5 pm at 123 Street Name Rd. with <Client Full Name>. Please tap “Start” in the beginning of the appointment, tap “Complete” at the end, and rate your customer.”

7. Stylists call the customer 5 minutes (or any other defined time) before appointment.

8a. If the customer cancels the appointment, send an message (e.g., a text or email) about the resulting charges, or no charges, depending on when it was cancelled, along with a link to the <Provider> cancellation policy. A non-limiting example of such a message follows:

“We are sad that you had to cancel your <Provider> appointment, but we look forward to serving you again in the future. For your convenience, we have provided a link to our cancellation policy. Your credit card will be charged based on the policy. Thanks again for choosing <Provider>, and please email us if you have any questions regarding your appointment cancellation. Make it a great day, The <Provider> Team

8b. If the appointment is cancelled by the customer, or if the stylist is removed from the appointment by the administrator, send a text to the stylist:
Appointment Cancellation: 8/25 @5 pm at 123 Street Name Rd. with <Client Full Name>.
Remove that appointment from the stylist's schedule tab on stylist app

8c. If the stylist wants to cancel to appointment, for now, they will need to call the administrator.

9. At the appointment, the stylist taps “Start” on the stylist app.

10. If the start time is 10 min later that the appointment time, text the administrator:
“Late Appointment: <# Appointment ID>, <appointment url>”
Indicate the late appointments in the administrator.

11. If a stylist starts the appointments late more than 3 times in 3 months (or any other defined number in any other defined time), notify (e.g., text or email) the administrator about this occurrence. Examples and parameters for such messaging include but are not limited to the following:
“3 Late Appointments in 3 Months: <Stylist Name>, <stylist profile url>”
Reset a counter of late appointments automatically every 3 months (or any other defined time).

12. Once the appointment is done, the stylist taps “Complete” on the Stylist App

13a. Upon tapping “Complete,” open the rate/review screen so that the stylist can rate (required) and review (optional) the customer. Preferably do not let the stylist leave the rating screen unless they rate the customer.

13b. Upon tapping “Complete,” send push and inapp notification to the customer to rate the stylist (for example, 1 to 5 stars) and leave a tip.
“Rate your stylist.”
“Add Tip” button on the rate/review screen.
Upon tapping “Add Tip” button, display 3 options to choose from: 10%, 15%, and 25% (or any other defined options).

13c. Upon tapping “Complete,” send a text to the customer to rate the stylist via text: “Please review your stylist. Text “5” for great and “1” for bad experience. Thank you for using <Provider>.”

14a. When the customer submits the stylist rating with or without the tip, process the payment.
If the customer doesn't rate the stylist in an hour (or any other defined time), process the payment.
If the customer rates the stylist after an hour (or any other defined time) with a tip, process the tip payment separately (Is this possible?)

14b. If the stylist is average rating below 4.3 (or any other defined number), send a messages (e.g., text or email) to administrator, such as but not limited to “Review Stylist: <Stylist Name>, <Average Rating>, <stylist profile url>”

15. Send “Thank you/receipt” email to the customer.

16. Send email & text on customer's birthday with discount offer:
For example, send an offer a week before the birthday.
“Happy early birthday from <Provider>. Book a <Provider> service between now and your birthday for for 30% off!”
Unique promo code needs to be auto generated to avoid fraud.

17. If a customer doesn't book another appointment 2 weeks after the last appointment, send a message (e.g., text or mail) and preferably push and/or inapp notifications to book an appointment. A non-limiting example of such a message follows:

“We have missed your beautiful smile and would like to remind you that at <Provider>, we are Bringing Beauty to Your Door! Please book your next <Provider> service today whether you need a blowout, an updo, or a visit from one of our talented makeup artists. Whether you have a special event, a night out with the girls, or want to be pampered morning, day, or night, <Provider> is here for you. Thanks for choosing <Provider>. We look forward to serving you soon! Make it a great day, The <Provider> Team”

18. Send reminder text to Stylist every morning at 5:00 am (or any other defined time) to check in.
Please check in on your <Provider> app so you can claim new appointments and we can put more money in your pocket!
In order to make them check in, we need to make them check out at some point daily.

A check may be made after 3 hours (or any other defined time) of inactivity.

19. Send reminder text to check in if they don't check in within 48 hours (or any other defined time). An example of such a reminder follows:

“You have not checked into your <Provider> app in the last 48 hours (or any other defined time). Please do so ASAP so we can deliver new appointment opportunities to you. Thank you for being part of the <Provider> Team!”

Group Booking Selection System

A screen may be provided for booking a group order. A person who selects just one server and date can then select multiple orders and see a multiplier effect.

Custom Group Ordering System and Combination System

In some aspects, users can multiply the order pricing based on an ascending numerical scale and do combinations of service orders that automatically generate a summation of the pricing structure through compiled left/right panning numbered thumbnails.

Various information including images and tables that may be used and/or generated by one or more computing devices to implement aspects of the subject technology are illustrated in appendices that accompany the incorporated provisional patent application. Group Bookings (multiple bookings) also apply to the situations listed above and multiply the geographical ordering process. Again, those appendices are incorporated into and form a part of this application. The subject technology is not limited to any of the details of the incorporated appendices.

Aspects of the subject technology are described below with respect to the figures of this document.

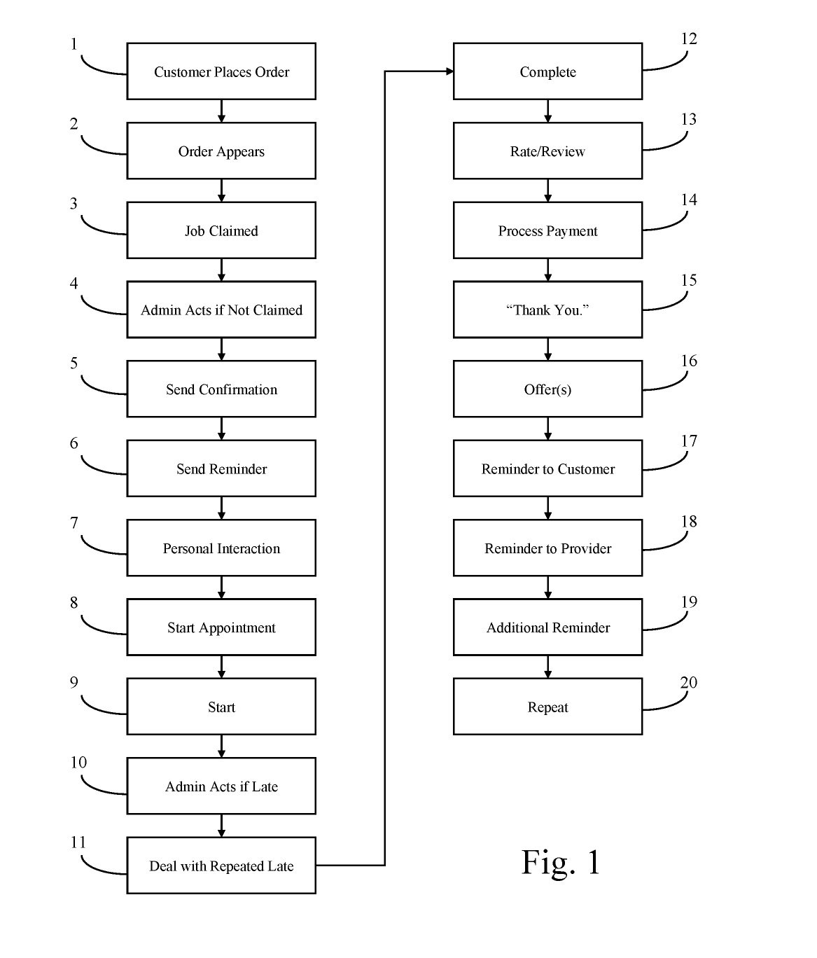

FIG. 1 illustrates process flow steps related to aspects of the subject technology. Steps 1 to 19 in the figure directly correspond to those described above, which are identical to the steps described in the incorporated provisional application from which this document claims priority. The only additional step is step 20, which indicates that the process may be repeated. Repetition of steps is disclosed in the incorporated provisional application.

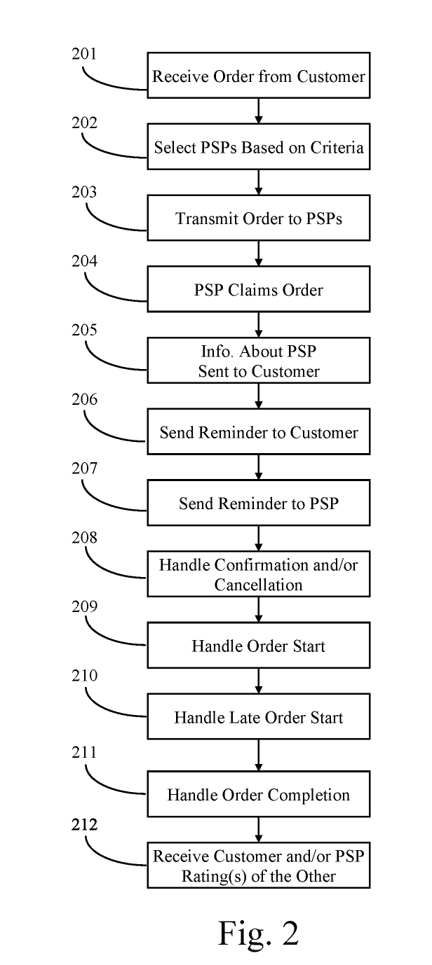

FIG. 2 also illustrates aspects of the subject technology. The steps in this figure are shown and discussed from the perspective of a computing device (e.g., web server) that interacts with computing devices used by a customer and one or more personal service providers (abbreviated as PSPs in the figure). Corresponding steps performed by those other computing device are implied; namely, if information is transmitted to a customer or personal service provider, their computing device performs the step of receiving that information, and vice versa.

In FIG. 2, an order from a customer is received in step 201. In some aspects, the order may include an order for a combination of personal professional services. For example, the order may be for braiding, “blowout,” and fingernail services for one or more customers. For another example, the order may be for some combination of electrical, plumbing, and/or other general contracting services. For yet another example, the order may be for delivery of food and non-food items. Combinations of these and other services are within the scope of the subject technology.

One or more personal service providers are selected in step 202 based on at least one criteria including skillsets of the personal service providers. Examples of the criteria include whether or not the personal service provider can perform the service(s) requested by the customer's order. For example, the skillsets may be whether or not the personal service provider can and/or is licensed to perform certain professional services related to styling services (e.g., involving hair, makeup, fingernails, etc.), other professional services (e.g., involving plumbing, electrical, general contracting work, etc.), delivery of food and non-food items, and the like. Other examples of the criteria may include one or more of a distance from the first other computing device, a distance from the customer, or a geography.

The order is transmitted to the selected personal service providers in step 203. A claim for the order from at least one personal service provider is received in step 204. Information about the service provider associated with the claim is transmitted to the customer in step 205.

Additional steps may include transmitting a reminder about the order to the customer in step 206, transmitting a reminder about the order to the personal service provider associated with the claim in step 207, receiving a confirmation or cancellation of the order from the customer and transmitting the confirmation or cancellation to the at least one of the one or more personal service providers associated with the claim in step 208, and/or receiving that service of the order has started in step 209. Further steps may include notifying an administrator that the at least one of the one or more personal service providers associated with the claim started the service of the order late in step 210, receiving that the service of the order has been completed in step 211, and/or receiving a rating or ratings of the customer and/or personal service provider from the other in step 212.

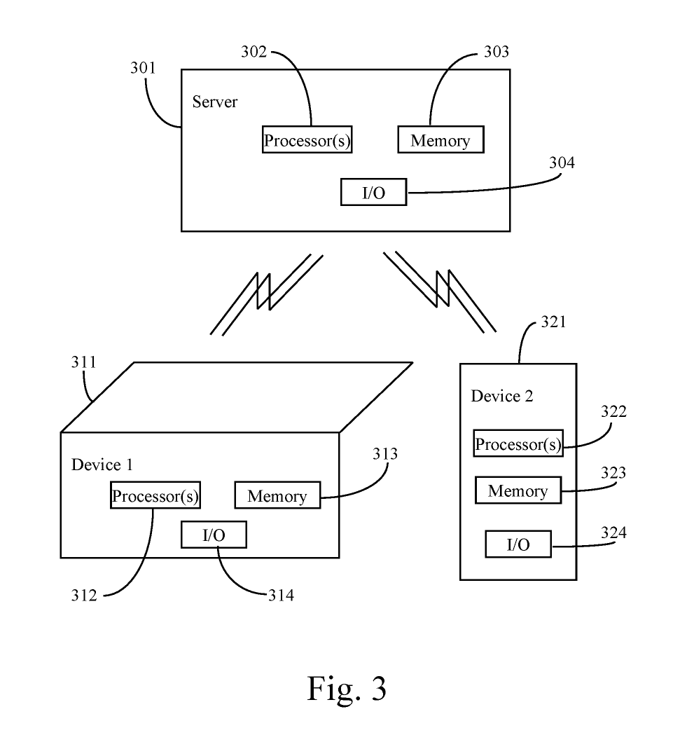

FIG. 3 illustrates hardware that may be used to implement aspects of the subject technology. In general, one or more input/output mechanisms in one or more computing devices may be used to enable interaction with at least a customer through at least a first other computing device and one or more personal service providers through one or more second other computing devices.

For example, device 301 represents a computing device such as a web server or other network interconnected device. Such interconnection may include but is not limited to connection via the World Wide Web, one or more private networks, and the like. Device 301 preferable includes one or more processors 302, memory 303 that stores information and/or instructions for carrying out aspects of the subject technology, and input/output mechanism 304 for interacting with other devices and/or users. Alternatively, some of these elements may reside in other devices, for example in a distributed computing network, a virtual computing architecture, or the like.

Device 311 represents a personal computing device in the form of a laptop or other computer. The device preferable includes one or more processors 312, memory 313 that stores information and/or instructions for carrying out aspects of the subject technology, and input/output mechanism 314 for interacting with other devices and/or users. Alternatively, some of these elements may reside in other devices, for example in a distributed computing network, a virtual computing architecture, or the like.

Device 321 represents a mobile computing device in the form of a smart phone or the like. The device preferable includes one or more processors 312, memory 313 that stores information and/or instructions for carrying out aspects of the subject technology, and input/output mechanism 314 for interacting with other devices and/or users. Alternatively, some of these elements may reside in other devices, for example in a distributed computing network, a virtual computing architecture, or the like.

In aspects of the subject technology, device 301 is part of an auto-selection system that may be accessed via devices such as devices 311 and/or 321 in order to allow selection of a personal service provider as shown and described in the other figures and the incorporated provisional application. Interaction between devices may be via wired communication (e.g., Ethernet), wireless communication (e.g., WiFi or mobile phone network), some combination thereof, or any other form of communication.

In some aspects, device 301 is a web server and interaction among the devices is over the World Wide Web. For example, a personal service provider or potential personal service provider may log into a web page provided by or through the server. The web server may then be used to provide appropriate screens based on the personal service provider's login information. Likewise, a customer or potential customer may log into the web page or another web page provided by or through the server. The web server may then be used to provide appropriate screens based on the customer's login information. Other architectures may be used to perform aspects of the subject technology.

More generally, the subject technology may be implemented using one or more computing devices that include at least one tangible computing element. For example, the computing device may be a laptop computer, a desktop computer, a mobile computing device such as a smart phone or tablet computer, a server, a smart television, a game counsel, a part of a cloud computing system, or any other form of computing device. Each computing device may perform parts of the process described above, either alone or in conjunction with one or more other computing devices. One or more of the computing devices preferably store or access instructions for performing such processes.

The invention is in no way limited to the specifics of any particular embodiments and examples disclosed herein. For example, the terms “aspect,” “example,” “e.g.,” “preferably,” “non-limiting,” and the like denote features that may be preferable but not essential to include in some embodiments of the invention. In addition, details illustrated or disclosed with respect to any one aspect of the invention may be used with other aspects of the invention. Additional elements and/or steps may be added to various aspects of the invention and/or some disclosed elements and/or steps may be subtracted from various aspects of the invention without departing from the scope of the invention. Singular elements/steps imply plural elements/steps and vice versa. Some steps may be performed serially, in parallel, in a pipelined manner, or in different orders than disclosed herein. Many other variations are possible which remain within the content, scope and spirit of the invention, and these variations would become clear to those skilled in the art after perusal of this application.

What is claimed is:

1. A personal service provider selection system, comprising:
one or more input/output mechanisms in one or more computing devices that enable interaction with at least a customer through at least a first other computing device and one or more personal service providers through one or more second other computing devices; and
one or more tangible computing elements in the one or more computing devices that perform steps comprising:
receiving an order from the customer;
selecting the one or more personal service providers based on at least one criteria including skillsets of the one or more personal service providers;
transmitting the order to the one or more personal service providers;
receiving a claim for the order from at least one of the one or more personal service providers; and
transmitting information to the customer about the at least one of the one or more personal service providers associated with the claim.

2. A personal service provider system as in claim 1, wherein the order comprises an order for a combination of personal professional services.

3. A personal service provider system as in claim 1, wherein the steps further comprise transmitting a reminder about the order to the customer.

4. A personal service provider system as in claim 1, wherein the steps further comprise transmitting a reminder about the order to the at least one of the one or more personal service providers associated with the claim.

5. A personal service provider system as in claim 1, wherein the steps further comprise receiving a cancellation of the order from the customer and transmitting the cancellation to the at least one of the one or more personal service providers associated with the claim.

6. A personal service provider system as in claim 1, wherein the steps further comprise receiving that service of the order has started.

7. A personal service provider system as in claim 6, wherein the steps further comprise notifying an administrator that the at least one of the one or more personal service providers associated with the claim started the service of the order late.

8. A personal service provider system as in claim 6, wherein the steps further comprise receiving that the service of the order has been completed.

9. A personal service provider system as in claim 6, wherein the steps further comprise receiving a rating of the service of the order from the customer.

10. A personal service provider system as in claim 1, wherein the one or more computing devices comprise a web server; and
the first other computing device, the second other computing devices, or both comprise mobile computing devices.

11. A method of selecting a personal service provider, comprising:
using one or more input/output mechanisms in one or more computing devices to enable interaction with at least a customer through at least a first other computing device and one or more personal service providers through one or more second other computing devices; and
using one or more tangible computing elements in the one or more computing devices to perform steps comprising:
receiving an order from the customer;
selecting the one or more personal service providers based on at least one criteria including skillsets of the one or more personal service providers;
transmitting the order to the one or more personal service providers;
receiving a claim for the order from at least one of the one or more personal service providers; and
transmitting information to the customer about the at least one of the one or more personal service providers associated with the claim.

12. A method as in claim 11, wherein the order comprises an order for a combination of personal professional services.

13. A method as in claim 11, wherein the steps further comprise transmitting a reminder about the order to the customer.

14. A method as in claim 11, wherein the steps further comprise transmitting a reminder about the order to the at least one of the one or more personal service providers associated with the claim.

15. A method as in claim 11, wherein the steps further comprise receiving a cancellation of the order from the customer and transmitting the cancellation to the at least one of the one or more personal service providers associated with the claim.

16. A method as in claim 11, wherein the steps further comprise receiving that service of the order has started.

17. A method as in claim 16, wherein the steps further comprise notifying an administrator that the at least one of the one or more personal service providers associated with the claim started the service of the order late.

18. A method as in claim 16, wherein the steps further comprise receiving that the service of the order has been completed.

19. A method as in claim 16, wherein the steps further comprise receiving a rating of the service of the order from the customer.

20. A method as in claim 11, wherein the one or more computing devices comprise a web server; and
the first other computing device, the second other computing devices, or both comprise mobile computing devices.
